(19) United States
(12) Patent Application Publication
(10) Pub. No.: US 2015/0134385 A1
(43) Pub. Date: May 14, 2015

(54) PROCESS CONTROL AND GOVERNANCE METHOD

(71) Applicants: TERRENCE PHILLIPS, POWDER SPRINGS, GA (US); YONG-JONG YEN, JOHNS CREEK, GA (US); MIKE YOUNG, TUCKER, GA (US)

(72) Inventors: TERRENCE PHILLIPS, POWDER SPRINGS, GA (US); YONG-JONG YEN, JOHNS CREEK, GA (US); MIKE YOUNG, TUCKER, GA (US)

(21) Appl. No.: 14/074,982

(22) Filed: Nov. 8, 2013

(51) Int. Cl. G06Q 10/06

(52) U.S. Cl. CPC G06Q 10/06311
USPC 705/7.13

(57) ABSTRACT

A Process Control and Governance method is used to manage the entire process flow into several sub-processes. The process is overseen and managed by one Process Initiator, and is distributed to a layered execution structure consisting of a plurality of Process Executors. The Process Initiator and the Process Executors in all layers send messages corresponding to the tasks to a database system via a sending program. The database shows latest messages of all the processes, so that the Process Initiator can inquire and understand the latest progress of the processes in time.

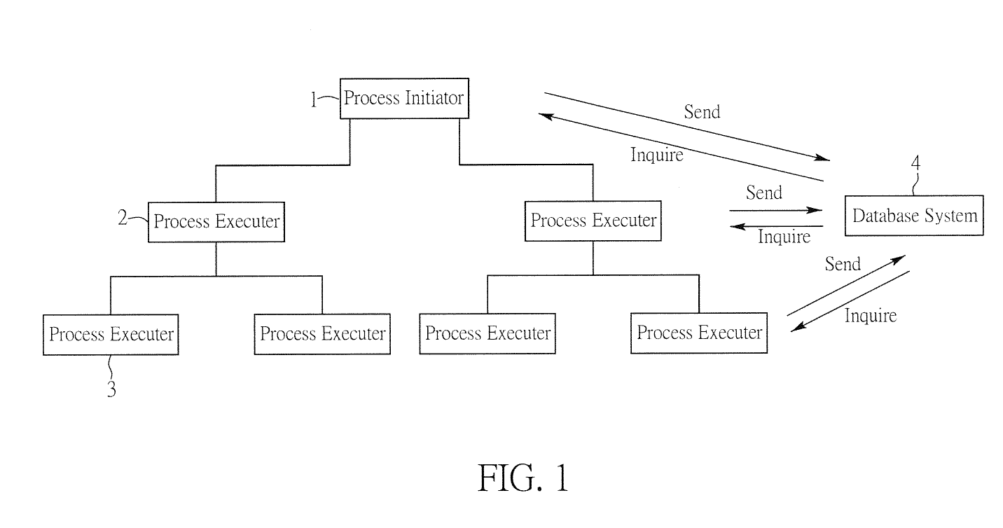

### BACKGROUND OF THE INVENTION

1. Field of Invention

The invention relates to a Process Control and Governance method and, in particular, to a management method that utilizes common tasks to monitor details of a process.

2. Related Art

To accomplish a job, one often divides the job into several tasks assigned to several teams to carry out. It is part of Process Control and Governance to monitor, control the execution efficiency and result of each team. In this case, the Process Initiator divides the entire process flow into several sub-processes and assigns the processes to several Process Executors. Each Process Executer further divides the task into sub processes or tasks and finds process Executors to finish the items. This is the concept of rapidly accomplishing a job by measured process flow units. In particular, one may get aides from Process Control and Governance software.

All conventional Process Control and Governance method and Process Control and Governance software are developed based on the above-mentioned concept. In practice, however, such a structure results in the fact that Process Initiators on an upper layer send tasks to the Process Executors in one layer lower, and these Process Executors further send tasks to the process Executors in their next layer. When a Process Executer evaluates and finds that the task cannot be accomplished on time, or even is too late to realize that, this information is reported to the Process Initiator through all the layers. It is often the case that the Process Initiator cannot discover and deal with the problem in time, resulting in serious delay. Moreover, to track the progress, the Process Initiator can only inquire the Process Executors in the next layer. If a Process Executer is not around, the progress tracking is also delayed and the Process Initiator cannot obtain the latest news.

In view of the foregoing, it is an objective of the invention to solve such problems.

### SUMMARY OF THE INVENTION

An objective of the invention is to provide a Process Control and Governance method that utilizes functions of commonly used task program so that the persons in charge in each layer of the process can update latest information in real time to a database system at any time. The Process Initiator can thus obtain the latest situation of the process in time.

To achieve the above-mentioned objective, the disclosed Process Control and Governance method for a Process Initiator to oversee and manage a process assigns the process to a multi-layered execution structure consisting of a plurality of Process Executors. The Process Initiator and the Process Executors in all layers send messages corresponding to the process to a database system via a sending program. The database shows latest progress of all the processes, so that the Process Initiator can inquire and understand the latest progress of the Process in real time which can be measured.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

The FIGURE is a schematic view showing the structure of the Process Control and Governance method according to the invention.

### DETAILED DESCRIPTION OF THE INVENTION

The present invention will be apparent from the following detailed description, which proceeds with reference to the accompanying drawings, wherein the same references relate to the same elements.

The disclosed Process Control and Governance method is used to manage numerous and concurrent processes. As shown in the FIGURE, the process is overseen and managed by a Process Initiator 1. Based on the concept of process flow and having assigned persons in charge in each layer, the Process Initiator 1 distributes process to the layered execution structure consisting of several Process Executors 2, 3. Therefore, the Process Initiator 1 assigns a process to the next layer. The Process Executors 2, 3 in the lower layers further divides the tasks into several items and assign them to the next layer. The process is hoped to finish quickly through process flows. The assignments, problems and results of the process are sent to a database system 4 by the Process Initiator 1 and the Process Executors 2, 3 via a sending program. The database 4 shows latest messages of all the processes, so that the Process Initiator 1 can inquire and understand the latest progress of the processes in measured units in real time, thereby ensuring that the process can be accomplished in time.

The sending program in this embodiment can be Microsoft Outlook in the Microsoft Office commonly used in companies. Under the tag of “Task,” there is a function of “To Do.” The Process Initiator 1 can use this function to import a process as a thing to do and then save to Outlook and then retrieved by the database system 4 from Outlook. Process Executors 2 in lower layers can learn the process assigned by the Process Initiator 1 from the database system 4. Each Process Executer 2 can also use Microsoft Outlook to send the process to the database system 4. Therefore, the Process Initiator 1 can check the progress of all the processes from the database system 4.

When Process Executors 3 in lower layers encounter any problems or want to report anything, they can also use Microsoft Outlook to send messages in the form of things to do to the database system 4. Thus, the manager 1 can check the progress at any time and monitor all tasks in time. He or she can immediately process and solve the problems. This will greatly increase the work efficiency and enable the project to finish in time.

In comparison with the prior art, the disclosed Process Control and Governance method has the advantage that the manager 1 does not need to inquire and track through the layers with a lot of time in order to understand the progress of the project. It also does not happen that the tracking may be interrupted if certain Process Executors 2 are not around. Merely using a computer to connect to the database system 4, the manager 1 can immediately check latest news of various tasks. Such an advantage is more prominent when the project is larger and more complicated. Through a good control of the project tasks in time, the Process Initiator 1 can prevent any delay due to traditional message transmissions.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A Process Control and Governance method for a Process Initiator to oversee and manage processes, comprising the steps of:
assigning processes to a layered execution structure consisting of a plurality of Process Executors;
sending messages of corresponding processes by the Process Initiator and the Process Executors via a sending program to a database system; and
showing the latest information of the processes on the database system for the Process Initiator to check and control the processes.
